(19) United States
(12) Patent Application Publication
(10) Pub. No.: US 2012/0044143 A1
(43) Pub. Date: Feb. 23, 2012

(54) OPTICAL IMAGING SECONDARY INPUT MEANS

(76) Inventor: John David Newton, Auckland (NZ)

(21) Appl. No.: 13/258,235

(22) PCT Filed: Mar. 25, 2010
(86) PCT No.: PCT/NZ2010/000051

§ 371 Date: Nov. 4, 2011

(30) Foreign Application Priority Data
Mar. 25, 2009 (AU) 2009901281

(51) Int. Cl. G06F 3/042; G06F 3/033; G06F 3/044; G06F 3/045; G06F 3/02; G06F 3/01; G06F 3/041

(52) U.S. Cl. 345/161; 345/156; 345/173; 345/174; 345/175; 345/168

(57) ABSTRACT

An optical imaging secondary input means for a computing system. The computing system includes a display screen having a viewing area and a computing device interfaced therewith. At least one primary input means, such as a coordinate input system, keyboard, mouse, etc., is interfaced with the computing device. The optical imaging secondary input means includes a reflective surface external to the viewing area of the display screen, at least one energy emitter for emitting energy toward the reflective surface, and at least one optical sensor for detecting the energy reflected from the reflective surface and outputting signals representing the same to the computing device. The computing device also executes one or more program modules for determining whether an object interacts with the secondary input means based on changes in the energy reflected from the reflective surface, as represented by the signals from the at least one optical sensor.

### RELATED APPLICATIONS

This application claims priority to Australian Provisional Patent Application No. 2009901281, entitled “A Touch Screen System Having A Reflective Portion,” which is incorporated herein by reference in its entirety and which was filed in the Australian Patent Office on Mar. 25, 2009.

### TECHNICAL FIELD

The present invention relates generally to secondary input means for computing systems and devices. More particularly, the present invention relates to optical imaging secondary input means for computing systems and devices, including touch sensitive systems and devices as well as other coordinate input systems.

### BACKGROUND OF THE INVENTION

Input means and methods for computing devices and the like have a long history of development. Conventional devices such as mice, keyboards and microphones have been in use for many years to provide input (i.e., data, commands, etc.) to computing systems. Recently, alternative forms of input means have been developed, such as coordinate input systems and devices. Coordinate input systems and devices translate movement by an object or user into coordinates or commands which may be utilized by a computing system.

Examples of coordinate input systems and devices are touch sensitive systems and devices. As used herein the terms “touch sensitive system” and “touch sensitive device” are used interchangeably to refer to any type of system or device that is capable of sensing or determining the position of an object, such as a finger, stylus, pointer, etc., relative to a reference frame, surface or coordinate space. Although the word “touch” is used, it is intended that it be understood that a physical contact does not need to occur in a touch system. Many technologies are known for implementing touch sensitive systems, including: resistive, surface acoustic wave, capacitive, surface capacitance, projected capacitance, strain gauge, optical imaging, dispersive signal technology, acoustic pulse recognition, coded LCD.

Touch sensitive systems are useful in a variety of applications. Example applications include personal computers (desktops, laptops, tablets, handheld computers, etc.), interactive whiteboards, gaming devices, mobile phones, GPS devices and many other electronic devices. When used in a personal computer, for example, a touch sensitive device may be integrated with a display screen and/or as a secondary input device, such as a touch pad, to simulate mouse movements. When used in an interactive whiteboard system, a touch sensitive device may be integrated with the display portion of the whiteboard for forming images on the surface of the whiteboard.

In devices which traditionally comprise a touch sensitive device combined with a display (the combination commonly referred to as a “touch screen”), it is often desirable to provide one or more secondary input means to assist the user in the operation of the device. In the example of a personal computer having a touch screen, a keyboard may serve as a secondary input means. The keys of the keyboard may have specially assigned functions corresponding to control commands for the touch screen, such as volume, brightness and contrast control, etc. In the example of an interactive whiteboard, a pointer holder may be provided as a secondary input means that can detect the presence or absence of a pointer.

Even in computing systems that do not include a touch sensitive device, it may be desirable to provide a secondary input means. For example in the case of a laptop having a keyboard as its primary input means, it may be convenient to provide secondary input means (e.g., switches and/or buttons) for controlling functions of the system such as volume, brightness, contrast adjustment, etc. These known types of secondary input means can be difficult to implement, often comprising separate capacitive and electronic elements which are expensive and cumbersome to integrate with the computing device of the touch sensitive system. In addition, these components must have lines of communication to the processing means of the computing system in order to execute the desired functions.

The present invention attempts to overcome the aforementioned disadvantages by providing an optical imaging secondary input means comprising at least a reflective portion.

### SUMMARY OF THE INVENTION

The present invention overcomes the aforementioned disadvantages of previously known secondary input means by providing a novel optical imaging secondary input means. A computing system in accordance with certain embodiments of the invention includes a display screen having a viewing area and a computing device interfaced with the display screen for executing one or more program modules for causing images to be displayed on the display screen. At least one primary input means is interfaced with the computing device. In addition, an optical imaging secondary input means is interfaced with the computing device. The secondary input means comprises a reflective surface external to the viewing area of the display screen, at least one energy emitter for emitting energy toward the reflective surface, and at least one optical sensor for detecting the energy reflected from the reflective surface and outputting signals representing the same to the computing device. The computing device also executes one or more program modules for determining whether an object (e.g., a finger, stylus or other pointer) is interacting with the secondary input means based on changes in the energy reflected from the reflective surface, as represented by the signals from the at least one optical sensor.

The primary input means of the computing system may be a keyboard, a mouse, a touch pad, or a joy stick. Alternatively, the display screen in combination with the primary input means may be a touch screen. In such embodiments, the touch screen may be implemented using any of the following technologies: resistive, surface acoustic wave, capacitive, surface capacitance, projected capacitance, strain gauge, optical imaging, dispersive signal technology, acoustic pulse recognition, and coded LCD.

In cases where the touch screen is implemented using optical imaging technology, the touch screen may include at least one energy emitter and at least one optical sensor, which may be the same energy emitter and optical sensor components of the optical imaging secondary input means. Thus, energy emitted by the at least one energy emitter may also be directed toward the viewing area of the display screen and reflected toward the at least one optical sensor by way of one or more reflective members (e.g., retroreflective members) positioned on a frame surrounding the viewing area. The at least one optical sensor may also detect the energy reflected from within the viewing area and output signals representing the same to the computing device. Accordingly, the computing device may also execute one or more program modules for determining touch point positions relative to the viewing area of the touch screen based on changes in the energy reflected toward the optical sensor(s) from within the viewing area, as represented by signals from the at least one optical sensor.

In some embodiments, the touch screen may comprise an interactive whiteboard and the reflective surface of the optical imaging secondary input means may be positioned on a tray mounted proximate to but external from the viewing area of the interactive whiteboard. Objects placed on the tray will cover at least a portion of the reflective surface and thereby reduce the energy reflected by the reflective surface. Therefore, the computing device determines that objects are placed on or removed from the tray based on the signals from the at least one optical sensor. The computing device may also be programmed to determine the positions on the tray in which the objects are placed or from which objects are removed, based on the signals from the at least one optical sensor.

In other embodiments, the primary input device of the computing system may be a keyboard. The reflective surface of the optical imaging secondary input means may be positioned on at least one portion of the keyboard and the at least one energy emitter and the at least one optical sensor may be positioned proximate to the display screen. In such a configuration, an object placed on or over the reflective surface reduces the energy reflected toward the optical sensor(s) by the reflective surface. The computing device thus determines that the objects is placed on or over the reflective surface based on the signals from the at least one optical sensor. In some configurations, at least a portion of the reflective surface may be assigned to a function of the computing system. When the computing device determines that the object is placed on or over the portion of the reflective surface, the computing device causes the function to be changed from a first state to a second state, thus implementing a simple button or switch. More complex interactions with the computing system may be similarly enabled in response an object touching on or near the portion of the reflective surface.

Other aspects of the invention provide an optical coordinate input system having an optical imaging secondary input means. The system include a computing device and an interaction area surrounded by one or more reflective members. At least one energy emitter emits energy into the interaction area. The energy is reflected toward at least one optical sensor from within the interaction area by the at least one reflective member, which may have retroreflective properties. The least one optical sensor detects the energy reflected from within the interaction area and output signals representing the same to the computing device. A secondary input means is also interfaced with the computing device and comprises a reflective surface external to the interaction area. The reflective surface may also have retroreflective properties. Energy emitted by the at least one energy emitter is also directed toward the reflective surface. The at least one optical sensor also detects the energy reflected toward the optical sensor(s) from the reflective surface and outputs signals representing the same to the computing device. The computing device executes one or more program modules for detecting and interpreting movement within the interaction area based on changes in the energy reflected from within the interaction area and for determining whether an object is interacting with the secondary input means based on changes in the energy reflected from the reflective surface.

Other aspects of the invention provide an optical touch sensitive system having an optical imaging secondary input means. The system includes a display screen having a viewing area surrounded by a frame, the frame having one or more reflective members applied thereto. The reflective members may have retroreflective properties. A computing device is interfaced with the display screen for executing one or more program modules for causing images to be displayed on the display screen. At least one energy emitter emits energy that is directed toward the viewing area of the display screen and is reflected toward at least one optical sensor from within the viewing area by way of the one or more reflective members. At least one optical sensor detects the energy reflected from within the viewing area and outputs signals representing the same to the computing device. A secondary input means is also interfaced with the computing device, wherein the secondary input means comprises a reflective surface external to the viewing area of the display screen. The energy emitted by the at least one energy emitter is also directed toward the reflective surface. The least one optical sensor also detects the energy reflected from the reflective surface and outputs signals representing the same to the computing device. The computing device also executes one or more program modules for detecting touch point positions relative to the viewing area of the display screen based on changes in the energy reflected toward the optical sensor(s) from within the viewing area and for determining whether an object is interacting with the secondary input means based on changes in the energy reflected from the reflective surface.

Other aspects of the invention provide an optical touch sensitive system having an optical imaging secondary input means. The system has a viewing area surrounded by a frame, which has one or more reflective members applied thereto. Unlike traditional touch sensitive systems, the frame extends beyond the display screen in at least one direction, such that the viewing area encompasses the display screen and an expanded area. At least one indicia representing a button or switch is located within said expanded area. For example the indicia may be applied to a surface of a glass plate that is applied to the front surface of the frame so as to cover the viewing area. A computing device may be interfaced with the display screen for executing one or more program modules for causing images to be displayed on the display screen. At least one energy emitter emits energy that is directed toward the viewing area and is reflected toward the optical sensor(s) from within the viewing area by way of the one or more reflective members. At least one optical sensor detects the energy reflected from within the viewing area and outputting signals representing the same to the computing device. The computing device also executes one or more program modules for detecting touch point positions relative to the display screen and relative to the at least one indicia located within the expanded area, based on changes in the energy reflected from within the viewing area.

These and other aspects and features of the invention will be described further in the detailed description below in connection with the appended drawings and claims.

### BRIEF DESCRIPTION OF THE DRAWINGS

FIG. 1 is an illustration of an exemplary optical touch screen system having an optical imaging secondary input means in the form of a tray, in accordance with certain exemplary embodiments of the present invention.

FIG. 2, comprising FIG. 2A and FIG. 2B, is an another illustration of the exemplary optical touch screen system of in FIG. 1, showing an exemplary use thereof.

FIG. 3, is a further illustration of the exemplary optical touch screen system of FIG. 1, showing a portion of the optical imaging secondary input means configured as a button or switch, in accordance with certain embodiments of the present invention.

FIG. 4 is an illustration of a computing device incorporating an optical imaging secondary input means, in accordance with certain exemplary embodiments of the present invention.

FIG. 5 is an illustration of an optical touch sensitive system incorporating an optical imaging secondary input means, in accordance with certain alternative embodiments of the present invention.

### DETAILED DESCRIPTION OF EXEMPLARY EMBODIMENTS OF THE INVENTION

The present invention provides a secondary input means for a computing system. The computing system may include a primary input means, such as a coordinate input system, a keyboard, a mouse, a joystick, etc. The secondary input means of the present invention is implemented using optical imaging touch sensitive technology and is therefore referred to herein as an “optical imaging secondary input means.” The optical imaging secondary input means may be combined with and utilize optical illumination/detection components of an optical coordinate input system, such as an optical touch screen system. Alternatively, the optical imaging secondary input means may have its own dedicated optical illumination/detection components and may be used in connection with any other type of coordinate input system, including touch sensitive systems implemented with resistive, surface acoustic wave, capacitive, surface capacitance, projected capacitance, strain gauge, dispersive signal technology, acoustic pulse recognition, or coded LCD technologies.

In general terms, optical imaging touch sensitive technology relies on a combination of energy emitter(s), reflector(s) or other light guide(s), optical sensor(s), digital signal processing, and algorithms to determine the position of a pointer or other object within a field of view of the optical sensor(s). By way of example, a frame or bezel may border a display screen, whiteboard, etc., to create a “viewing area.” One or more energy emitting sources may be positioned around or near the frame or bezel so as to emit energy (i.e., any type of electromagnetic radiation) into or across the viewing area. The energy, which may be ultraviolet, visible or infrared light, may be reflected or guided around the viewing area by way of reflectors and/or other light guides that are also positioned around or near the frame or bezel, so as to “illuminate” the viewing area. An object (e.g., a user's finger, a stylus or a pointer) placed within the illuminated viewing area disturbs the illumination and creates a shadow. One or more optical sensors (e.g., line-scanning sensors, area image sensors, etc.) may be positioned to detect fluctuations in illumination levels (i.e., shadows). Each optical sensor can be configured to output signals representing the position(s) of any detected shadow(s) relative to its field of view. In some systems, output signals from two or more optical sensors may be used to determine the position of the object relative to the overall viewing area, for example using triangulation or other known methods.

Accordingly, the optical imaging secondary input means of the present invention comprises at least one reflective surface that is separate from the viewing area of the touch screen. The reflective surface is similarly illuminated by energy emitted from one or more energy emitters and reflects such energy toward one or more optical sensor. Each optical sensor detects the intensity level of the reflected illumination (or at least the presence or absence of reflected energy) and generates an output signal representing the same. An illumination level detected at any given time may be compared with a reference illumination level to determine if the optical imaging secondary input means is being “touched” by a finger, stylus, pointer or other object.

For example, the reference illumination level may be determined at a time when it is known that the reflective input means is or is not being touched. When this reference illumination level is determined to be greater or less than a subsequently detected illumination level by more than a defined threshold amount, it may be concluded that the reflective input means is being touched or not touched. As is known in the art, any such threshold amount factored into a touch calculation may be used to account for changes in ambient energy levels or other relevant fluctuating conditions. As is also known in the art, touch calculations are performed by software and/or hardware of the touch screen system.

The one or more optical sensors used for the optical imaging secondary input means may also be configured to detect the position of a touch on or near the reflective surface, using known techniques. The systems and methods of the present invention thus provide a cost effective way of incorporating secondary input means for a touch sensitive system or any other type of computerized system or device. Consequently, the present invention is well suited for use in systems and devices such as whiteboards, laptops, desktop computers, mobile phones, PDAs, gaming devices, office machinery, and other computing devices.

Reference will now be made in detail to various and alternative exemplary embodiments and to the accompanying drawings, with like numerals representing substantially identical structural elements. Each example is provided by way of explanation, and not as a limitation of the scope of invention. It will be apparent to those skilled in the art that modifications and variations can be made without departing from the scope or spirit of the present disclosure and the appended claims. For instance, features illustrated or described as part of one embodiment of the invention may be used in connections with another embodiment to yield a still further embodiment. Thus, it is intended that the present disclosure includes any and all modifications and variations as come within the scope of the appended claims and their equivalents.

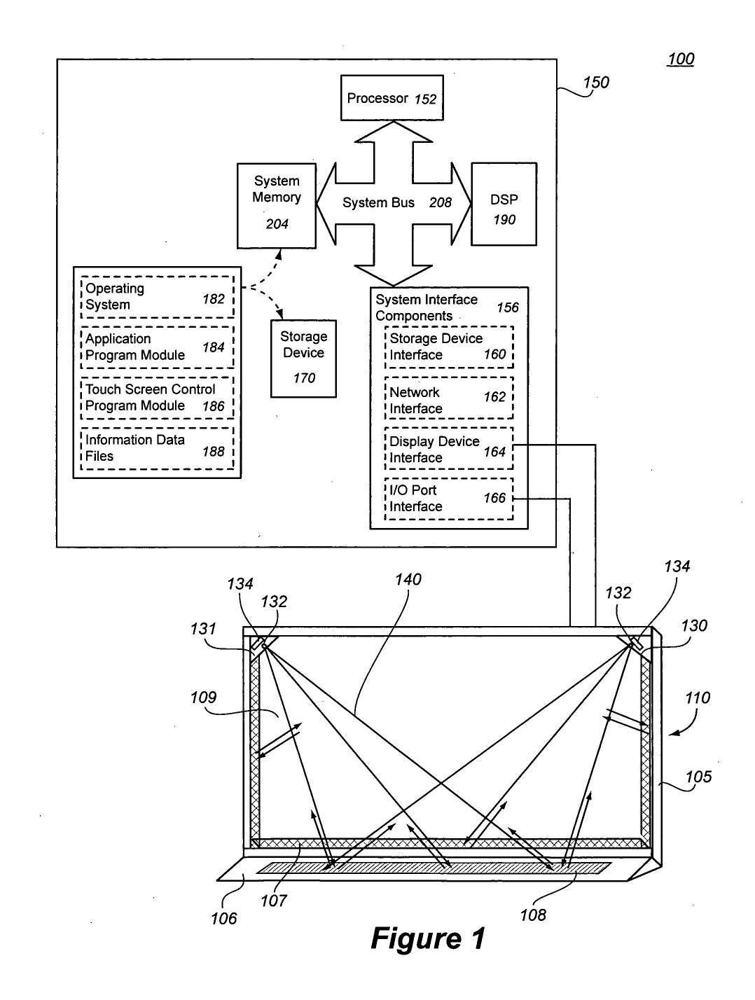

FIG. 1 is an illustration of an exemplary optical touch screen system 100 having an optical imaging secondary input means in the form of a tray 106. The exemplary touch screen system 100 includes a touch screen 110 interfaced with a computing device 150, which may execute software for detecting objects (for example, sensing the presence and/or position of a pointer) on or near the touch screen 110 and the tray 106.

The touch screen system 100 illustrated in FIG. 1 is intended to represent an exemplary optical touch screen system. Those skilled in the art will recognize that many other optical touch screen system configurations exist and are well suited for the present invention. As shown by way of example, a frame 105 borders the touch screen 110 to create a viewing area 109 therein. Optical position sensing subsystems 130, 131 are positioned in two or more corners of the touch screen 110. Each optical position sensing subsystem 130, 131 includes an energy emitter 132 for emitting electromagnetic radiation into the viewing area 109. Examples of suitable energy emitters 132 include infrared light emitting diode (LED), fluorescent tubes, etc. Each optical position sensing subsystem 130, 131 may further include an optical sensor 134, such as a line scan sensor or area scan camera. The optical sensors 134 can be based on complementary metal oxide semiconductor (CMOS), charge coupled device (CCD) or charge injection device (CID) technologies, which are known in the art.

The energy emitted by the energy emitters 132 is directed into the viewing area 109, where it is reflected toward the optical sensor(s) 134 by one or more reflective member 107 (e.g., reflectors, mirrors, etc.) or other type of energy guide (e.g., prisms, light channels, etc.), which may be applied to the frame 105. Reflective member(s) 107 may comprise a generally inexpensive material that is commonly produced in the form of films, tapes or paints, all of which can be easily applied to the frame 105 of a display screen 110 with glue or other adhesives. In the embodiment shown in FIG. 1, where an energy emitter 132 and an optical sensor 134 are positioned in close proximity to each other, it may be preferred that the reflective member(s) 107 have retroreflective properties whereby light is reflected back towards its source. The energy emitted into and reflected from within the viewing area 109 is shown in the figure as energy beams 140. This energy “illuminates” the viewing area 109 of the display screen 110. A pointer or other object placed within the viewing area 109 disturbs the illumination and creates a shadow effect that can be detected by the optical sensors 134. The position of the object, which corresponds to a touch point, can be determined through signal processing and software algorithms, as is well known in the art.

Those skilled in the art will recognize that the foregoing general principles of optical touch screen technology similarly apply to optical coordinate input systems that do not include a display screen. Such system may be configured to detect movements or gestures made within a defined area (referred to herein as an “interaction area”). Thus, for example, an interaction area may be surrounded by a frame or other array of reflective members. Energy emitters may be positioned so as to emit energy into the interactive area. The emitted energy may be reflected from within the interaction area by the reflective members and detected by optical sensors. Movements and gestures within the interaction area will cause changes in the energy reflected from within the interaction area, which can be detected by the optical sensors and interpreted by software running on the computing device.

Returning to the embodiment shown in FIG. 1, tray 106 is designed to hold auxiliary components, such as markers, pointers, and erasers. Tray 106 includes a reflective surface 108, which may comprise one or more reflective member disposed on the surface of the tray 106. In the embodiment shown in FIG. 1, the reflective surface 108 reflects energy emitted from the emitters 132. This reflected energy is detected by the optical sensors 134.

In some embodiments, the reflective member(s) 107 of the touch screen may be positioned (or addition reflective members or light guides may be added) to ensure that a sufficient amount of the energy emitted by the emitters 132 is directed to the reflective surface 108. In other embodiments one or more additional energy emitters 132 may be added to the system for the purpose of illuminating the reflective surface 108. In still other embodiments, additional optical sensors 134 may be provided for detecting the energy reflected from the reflective surface 108. Other positions for the tray 106 relative to the touch screen 110 are also possible. Thus, many other configurations are possible and the invention is not intended to be limited to the embodiment shown in FIG. 1, where the tray 106 is positioned along one edge of the touch screen 110 and a pair of optical position sensing subsystems 130, 131 are positioned in the corners of the touch screen 110 that are furthest away from the tray 106. Furthermore, the optical imaging secondary input means is not limited to a tray 106 configuration; any object or surface external to the touch screen 110 could be used for the optical imaging secondary input means.

When at least a portion of the reflective surface 108 of the tray 106 is covered or blocked from view of the optical sensors 134, the optical sensors 134 will sense a decrease in the illumination level relative to the covered or blocked portion of the tray 106. This is because the object covering or blocking the portion of the tray 106 will absorb more, or at least not reflect as much, of the energy emitted by the emitters 132, as compared to the reflective surface. Thus, the optical sensors 134 may be used to determine the presence or absence of an object on over the tray 106 by detecting fluctuation in the illumination levels of the reflected energy. An object present on or over the tray 106 or a portion thereof may be treated as a touch situation, where as the absence of an object on or over the tray 106 or a portion thereof may be treated as a non-touch situation. Those skilled in the art will appreciate that the reflective member(s) 107 and the reflective surface 108 of the tray 106 may be chosen to have highly reflective properties and/or retroreflective properties. Depending on the configuration of the system, the reflective member(s) 107 and the reflective surface 108 of the tray 106 may have the same or different reflective properties.

The optical position sensing subsystems 130, 131 transmit data signals regarding detected illumination levels (or variation therein) to a computing device 150 that executes software for processing the data signals and calculating the location of a touch or object relative to the touch screen 110 and the tray 106. The computing device 150 may be functionally coupled to the touch screen 110 by a hardwire or wireless connection. The computing device 150 may be any type of processor-driven device, such as a personal computer, a laptop computer, a handheld computer, a personal digital assistant (PDA), a digital and/or cellular telephone, a pager, a video game device, office equipment, etc. These and other types of processor-driven devices will be apparent to those of skill in the art. As used in this discussion, the term “processor” can refer to any type of programmable logic device, including a microprocessor or any other type of similar device.

The computing device 150 may include, for example, a processor 152, a system memory 154 and various system interface components 156. The processor 152, system memory 154 and system interface components 156 may be functionally connected via a system bus 158. The system interface components 156 may enable the processor 152 to communicate with peripheral devices. For example, a storage device interface 160 can provide an interface between the processor 152 and a storage device 170 (e.g., a removable or non-removable disk drive). A network interface 162 may also be provided as an interface between the processor 152 and a network communications device (not shown), so that the computing device 150 can be connected to a network.

A display screen interface 164 can provide an interface between the processor 152 and the display screen of the touch screen 110. The display screen may be a computer monitor or any other type of dynamic or static display. One or more input/output (“I/O”) port interfaces 166 may be provided as an interface between the processor 152 and various input and/or output devices. For example, the optical position sensing assemblies 130, 131 or other suitable components of the touch screen 110 may be connected to the computing device 150 via suitable input/output port interface(s) 166.

A number of program modules comprising computer executable instructions may be stored in the system memory 154 and/or any other computer-readable media associated with the storage device 170 (e.g., a hard disk drive, etc.). The program modules may include an operating system 182. The program modules may also include an application program module 184 for displaying images or other information on a touch screen 110. Other aspects of the exemplary embodiments of the invention may be embodied in one or more touch screen control program module(s) 186 for controlling the optical components 130, 131 of the touch screen system 100 and/or for calculating touch locations relative to the touch screen 110 and the tray 106. Furthermore, images and other data displayed by the application program module 184, as well as other data used by the system, may be stored in one or more data files 188 on any computer-readable medium associated with the computing device 150.

Certain embodiments of the invention may include a digital signal processing unit (DSP) 190 for performing some or all of the functionality ascribed to the touch screen control program module 186. As is known in the art, a DSP 190 may be configured to perform many types of calculations including filtering, data sampling, and triangulation and may be used to control the modulation of the energy emitters 132 of the optical components 130, 131. The DSP 190 may include a series of scanning imagers, digital filters, and comparators implemented in software. The DSP 190 may therefore be programmed for calculating touch locations and cursor positions relative to the touch screen 110 or the tray 106, as described herein. Those of ordinary skill in the art will understand that the functions of the DSP 190 may also be implemented by other means, such as by the operating system 182, by another driver or program module running on the computerized device 150, or by a dedicated touch screen controller device (not shown). These and other means for calculating touch locations relative to the touch screen 110 and the tray 106 are contemplated by the present invention.

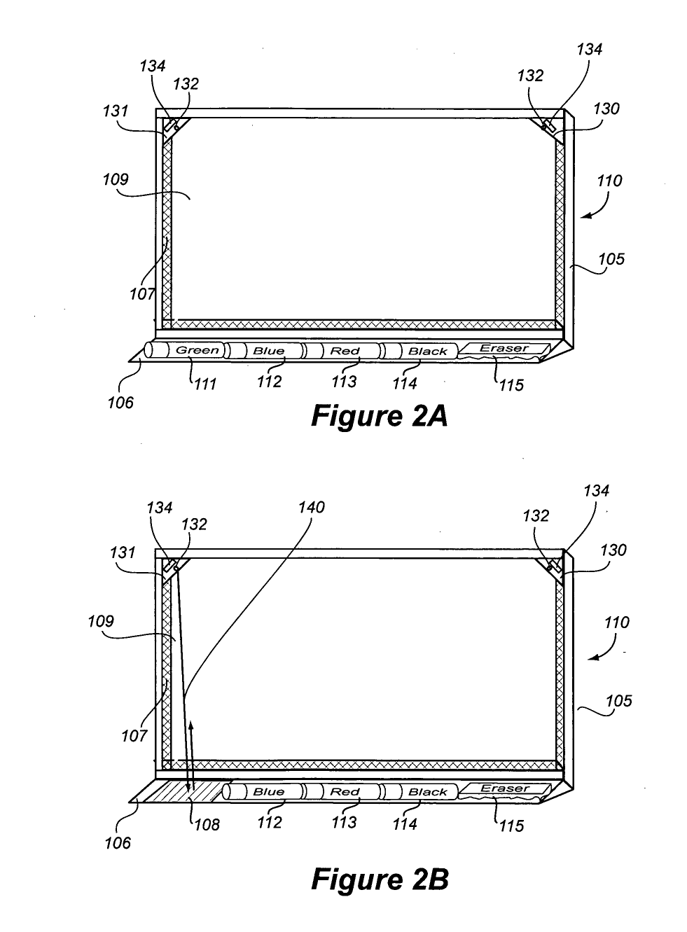

FIG. 2, comprising FIG. 2A and FIG. 2B, is an another illustration of the exemplary optical touch screen system 100 shown in FIG. 1. As shown in FIG. 2, the tray 106 may be used for storing objects, such as markers 111-114, an eraser 115, and/or other pointers used in connection with an interactive white board or other touch screen 110. As shown in FIG. 2A, when each of the objects 111-115 is present on the tray 106, the reflective surface 108 of the tray is covered and is thus not exposed to the energy emitted from the energy emitters 132. With the reflective surface fully covered, the optical sensors 134 will detect a comparatively small amount of amount of energy being reflected by the tray 106 (some amount of energy will likely be reflected by the objects 111-115 themselves), which may be interpreted by the touch screen control program module 186 (or DSP 190) as if the entire tray 106 is being touched. In some embodiments, the reflective surface 108 is applied to only selected positions along the tray and such positions are designed or otherwise designated for receiving certain objects 111-115.

As shown in FIG. 2A, when one of the objects 111 is removed from its position on the tray 106, a portion of the reflective surface 108 will be exposed, and this will increase the amount of energy being reflect from the tray 106 at that position. This increased illumination will be interpreted by the touch screen control program module 186 (or DSP 190) as if the tray is no longer being touched at that position. Thus, the touch screen control program module 186 (or DSP 190) may be configured to determine not only whether any or all of the objects 111-115 have been removed from the tray 106, but from which position the objects 111-115 has been removed.

In other embodiments of the invention, reflective surfaces 108 may be applied to each of the objects 111-115 themselves, rather than to the tray. In such embodiments, the presence of an object on the tray 106 would register as a non-touch and the absence of the object would be registered as a touch.

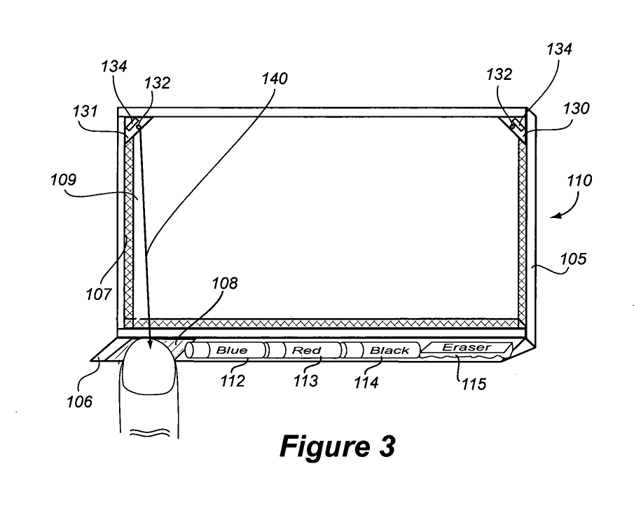

In still other embodiments, the reflective surface 108 of the tray 106 (or other object) may be used to provide a “switch” or “button” input means that toggles between two or more operational states, or otherwise enables more complex functionality. As shown in FIG. 3, by way of example, a portion of the reflective surface 108 of the tray 106 may remain exposed (i.e., not covered by an object 111-115) in normal operation. This exposed portion of the reflective surface 108 may be treated as a switch or button assigned to a particular control or function or the touch sensing system 100. When the optical sensors 134 detect that the user has touched the exposed portion of the reflective surface 108, the computing device 150 may be configured to change the control or function from a first state to a second state. Similarly, when the optical sensors 134 detect that the user has touched the exposed portion of the reflective surface 108 a second time, the computing device 150 may be configured to change the control or function from the second state to a next state or back to the first state. For example, such a button or switch configuration could be used to control the power ON/OFF states of the touch screen 110 and/or to control contrast and/or brightness adjustments.

In certain exemplary embodiments of the invention, the optical sensors 134 may be configured to distinguish between the energy being reflected from the reflective member(s) 107 of the touch screen 110 and the reflective surface 108 of the tray 106. This is helpful in alleviating any problems in differentiating touches relative to the touch screen from touches relative to the tray 106. For example, in certain embodiments (when the optical sensor 134 is an area camera or similar), the reflective surface 108 of the tray may be viewed or imaged by a different portion of the pixel map of the optical sensor 134 as compared to the reflective member(s) 107 of the touch screen. In other embodiments, the reflective member(s) 107 of the touch screen may be viewed by a first optical sensor 134 or pair of optical sensors 134 and the reflective surface 108 of the tray 106 may be viewed by one or more other optical sensors 134. Those skilled in the art will appreciate other methods to distinguish between the reflective member(s) 107 of the touch screen 110 and the reflective surface of the tray 106.

In certain embodiments of the invention, the markers 111-114 held on the tray 106 may be traditional whiteboard markers or pens (e.g., so-called dry erase markers). Each marker 111-114 may be a different color and may have a designate position on the tray 106. Assuming in the most simplistic case that the user removes only one marker (e.g., marker 111) at a time from the tray 106 and uses that marker 111 to mark the viewing area 109 of the touch screen 110, which may include a traditional whiteboard, the optical imaging secondary input means of the present invention will allow the touch sensitive system 100 to determine which color marker 111 is being used, e.g., for purposes of digitally recording the markings applied to the whiteboard.

In embodiments where the touch screen 110 does not include a traditional whiteboard and is not intended to be marked with a marker 111-114, the markers 111-114 held on the tray 106 may be “inkless” (i.e., non-marking) pens. Each pen 111-114 may be assigned a particular color (e.g., red, green, blue or black) and a designated position on the tray 106. Thus, the designated color of each pen may be dependent upon the position of the tray 106 in which the pen is placed or from which it is removed. When a pen 111 is removed from the tray 106, the optical imaging secondary input means of the present invention and determines the location of the resulting increased reflected energy. Based on the location of the increased reflected energy, the system determines which pen 111 has been removed from the tray 106 and thus the color that has been assigned to it. For example, if a user removes a pen from the “green” section of the tray 106, the system will execute a command to enable that anything digitally drawn or written on the touch screen 110 is displayed in the color green. If the user replaces the “green” pen and then removes the “blue” pen, any subsequent digital markings on the touch screen 110 will be displayed in the color blue. Additionally, for example, if the user removes a pen from an “eraser” section of the tray 106, the system will execute a command to erase any portion of the digital drawing that are subsequently touched by that pen.

There may arise a situation when an object 111-115 is removed from the tray 106 (thus exposing a section of the reflective surface 108) and then, prior to the object being returned to the tray 106, a finger or other object is placed on or over the exposed reflective material 108, inadvertently blocking it from the field of view of one or more optical sensor 134. This situation may potentially confuse the optical imaging secondary input means into incorrectly determining that the object has been returned to its designated section of the tray. In some embodiments of the invention, the optical imaging secondary input means may be designed to alleviate this potential problem by using data signals generated by two (or more) optical sensors 134 to effectively determine whether any portion of the reflective surface 108 of the tray 106 is exposed, and, if so, then determining that the object has not been returned to the tray. In this manner, the optical imaging secondary input means can eliminate false positives and will more accurately determine when an object 111-115 is removed from or returned to the tray 106.

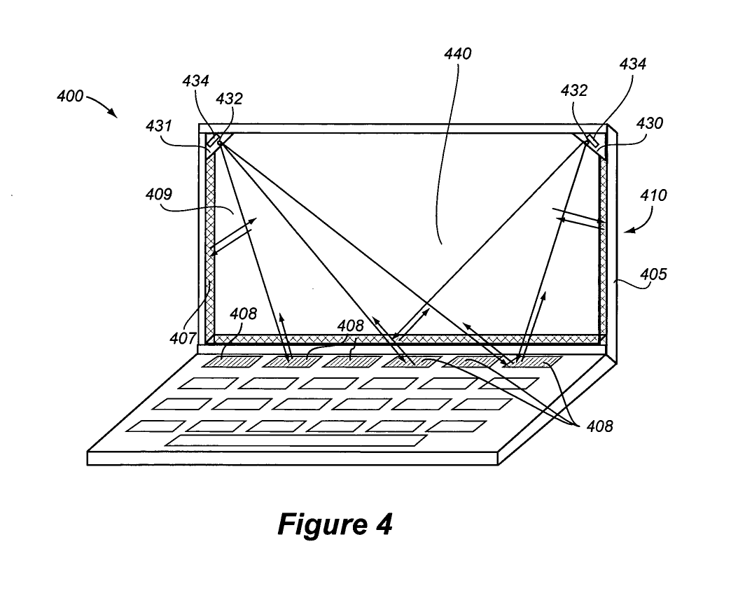

In another possible application, the optical imaging secondary input means of the present invention may be incorporated into a laptop or other computer, as illustrated by way of example in FIG. 4. Similar to the touch sensitive system described with reference to the prior figures, the exemplary computer 400 may include a touch screen 410 and a frame or bezel 405 may surrounding the touch screen 410. A reflective material 407 may be applied to the inner surface of the frame 405. Optical sensors 434 and energy emitters 432 may be located on or near the periphery of the frame 405 furthest away from a keyboard 460. A secondary input means may include a reflective surface 408 disposed below the touch screen 410. For example, the reflective surface 408 may be on or integrally formed with the housing of the computer 400 or the keyboard 460. The energy emitters 432 in conjunction with the reflective members of the touch screen 410 illuminate the viewing area 409 of the touch screen 410 and the reflective surface 408 of the secondary input means. The optical sensors 434 image both the viewing area 409 of the touch screen and the reflective surface 408 of the secondary input means. In this manner, the secondary input means may serve the function of a soft “button” or “switch”. The optical sensors 434 in conjunction with a touch screen control program module or DSP (neither of which are shown) may be configured to detect touches of the secondary input means and, in response, indicate that a “button” or “switch” has been “pressed” or “activated”, respectively. The computer 400 may then perform a command based on a pre-determined function assigned to the soft “button” or “switch.” There are many examples of possible uses for the soft “button” or “switch,” including but not limited to, volume up/down, power on/off, standby, sleep mode, mute, detection of closed laptop lid, and others. Those skilled in the art will appreciate other potential and advantageous uses of the soft “button” or “switch” functionality provided by certain embodiments of the present invention.

In yet other embodiments of the present invention, an optical imaging secondary input means may not necessarily be used in conjunction with a touch screen 100. For example, a laptop, mobile phone, gaming device or other computing device that does not include a touch screen 110 may incorporate an optical imaging secondary input means of the present invention rather than, or in addition to, a touchpad, keyboard and/or other common input device.

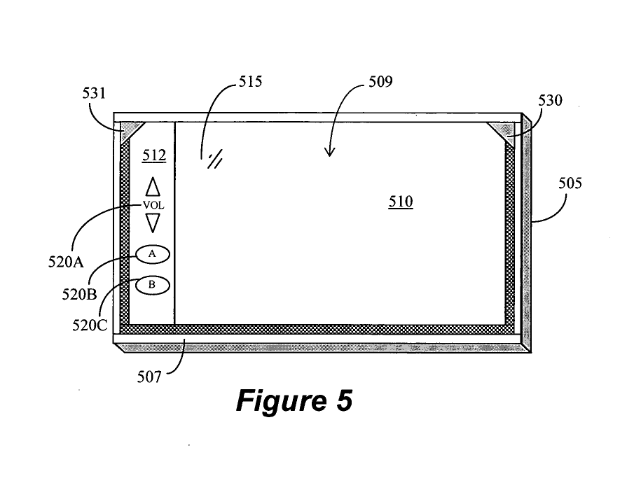

FIG. 5 is an illustration of an optical touch sensitive system incorporating an optical imaging secondary input means, in accordance with certain alternative embodiments of the present invention. As shown in the figure, the frame 505 surrounding the display screen 510 may be expanded in at least one direction to thereby increase the viewing area 509 of the system. The expanded area 512 of the viewing area may function as the optical imaging secondary input means, as will be described.

As previously noted, optical position sensing subsystems 530, 531 may be positioned in at least two corners of the frame 505 and reflective member(s) 507 may be applied to the frame 505. Thus, the energy emitted by energy emitters (not shown) will be reflected from within the viewing area 509 by the reflective member(s) 507 and detected by optical sensors (not shown). A glass plate 515 is applied to the front surface of the frame 505 so as to cover the viewing area 509. Because the viewing area 509 encompasses the display screen 510 and an expanded area 512, the optical touch sensitive system will be able to detect touch point positions relative to both the display screen 510 and the expanded area 512.

The expanded area 512 of the viewing area 509 may be designated with indicia representing buttons or switches 520A-C. For example these indicia 520A-C may be applied to the top or bottom surface of the glass plate 515, or may be etched or embedded in the glass plate 515. In other embodiments, the objects with the indicia 520A-C applied thereto may be positioned behind the glass plate 515. These and other manners for designating the expanded area 512 with button or switch indicia 520A-C will be recognized by those of skill in the art and are considered to be within the scope of the present invention.

With the configuration shown in FIG. 5, the optical touch sensitive system will be able to determine touch position locations relative to the display screen 510 and relative to the expanded area 512, which functions as a secondary input means. The portions of the expanded area 512 that are designated by button or switch indicia 520A-C may be assigned to certain function of the touch sensitive system. Thus, when the computing device (not shown) determines that an object is placed on or near one of the indicia 520A-C, the computing device causes the function assigned to that portion of the expanded area 512 to be toggled from a first state to a second state. As will be apparent to those of skill in the art, more complex interactions with the optical touch sensitive system may also be enabled in response to touches on or near one of the indicia 520A-C.

Based on the foregoing, it can be seen that embodiments of the present invention can provide an improved touch screen system having a reflective portion that provides a cost effective and seamless method of inputting data regarding user interaction with the system. Many other modifications, features and embodiments of the present invention will become evident to those of skill in the art. It should be appreciated, therefore, that many aspects of the present invention were described above by way of example only and are not intended as required or essential elements of the invention unless explicitly stated otherwise. Accordingly, it should be understood that the foregoing relates only to certain embodiments of the invention and that numerous changes may be made therein without departing from the spirit and scope of the invention as defined by the following claims. It should also be understood that the invention is not restricted to the illustrated embodiments and that various modifications can be made within the scope of the following claims.

What is claimed is:

1. A computing system having an optical imaging secondary input means, comprising:
a display screen having a viewing area;
a computing device interfaced with the display screen for executing one or more program modules for causing images to be displayed on the display screen;
at least one primary input means interfaced with the computing device; and
a secondary input means interfaced with the computing device, wherein the secondary input means comprises a reflective surface external to the viewing area of the display screen, at least one energy emitter for emitting energy toward the reflective surface, and at least one optical sensor for detecting the energy reflected from the reflective surface and outputting signals representing the same to the computing device; and
wherein the computing device further executes one or more program modules for determining whether an object is interacting with the secondary input means based on changes in the energy reflected from the reflective surface represented by said signals from the at least one optical sensor.

2. The computing system of claim 1, wherein the at least one primary input means is selected from the group consisting of: a keyboard, a mouse, a touch pad, and a joy stick.

3. The computing system of claim 1, wherein the display screen in combination with the at least one primary input means comprises a touch screen.

4. The computing system of claim 3, wherein touch screen is implemented using a technology selected from the group comprising: resistive, surface acoustic wave, capacitive, surface capacitance, projected capacitance, strain gauge, optical imaging, dispersive signal technology, acoustic pulse recognition, and coded LCD.

5. The computing system of claim 3, wherein touch screen is implemented using optical imaging technology;
wherein the touch screen comprises the at least one energy emitter and the at least one optical sensor that function as components of the optical imaging secondary input means;
wherein the energy emitted by the at least one energy emitter is also directed toward the viewing area of the display screen and is reflected from within said viewing area by way of one or more reflective members positioned on a frame surrounding the viewing area; and
wherein the at least one optical sensor also detects the energy reflected from within the viewing area and outputs signals representing the same to the computing device.

6. The computing system of claim 5, wherein the computing device further executes one or more program modules for determining touch point positions relative to the viewing area of the touch screen based on changes in the energy reflected from within the viewing area represented by said signals from the at least one optical sensor.

7. The computing system of claim 5, wherein the reflective surface of the optical imaging secondary input means is separate from the one or more reflective members of the touch screen.

8. The touch screen system of claim 7, wherein the reflective surface of the optical imaging secondary input means and the one or more reflective members of the touch screen are each selected from the group consisting of: reflective film, reflective tape, and reflective paint.

9. The computing system of claim 6, wherein the touch screen comprises an interactive whiteboard.

10. The computing system of claim 9, wherein the reflective surface of the optical imaging secondary input means is positioned on a tray mounted proximate to but external from the viewing area of the interactive whiteboard.

11. The computing system of claim 10, wherein objects placed on the tray cover at least a portion of the reflective surface and thereby reduce the energy reflected by the reflective surface; and
wherein the computing device determines that objects are placed on or removed from the tray based on said signals from the at least one optical sensor.

12. The computing system of claim 10, wherein computing device further determines the positions on the tray in which the objects are placed or from which objects are removed, based on said signals from the at least one optical sensor.

13. The computing system of claim 1, wherein the primary input device comprises a keyboard;
wherein the reflective surface of the optical imaging secondary input means is positioned on at least one portion of the keyboard; and
wherein the at least one energy emitter and the at least one optical sensor are positioned proximate to the display screen.

14. The computing system of claim 13, wherein an object placed on or over the reflective surface thereby reduces the energy reflected by the reflective surface; and
wherein the computing device determines that the objects is placed on or over the reflective surface based on said signals from the at least one optical sensor.

15. The computing system of claim 14, wherein at least a portion of the reflective surface is assigned to a function of the computing system; and
wherein when the computing device determines that the object is placed on or over the portion of the reflective surface, the computing device causes the function to be changed from a first state to a second state.

16. An optical coordinate input system having an optical imaging secondary input means, comprising:
a computing device;
an interaction area surrounded by one or more reflective members;
at least one energy emitter for emitting energy into the interaction area, said energy being reflected from within the interaction area by the at least one reflective member;
at least one optical sensor for detecting the energy reflected from within the interaction area and outputting signals representing the same to the computing device;
a secondary input means interfaced with the computing device and comprising a reflective surface external to the interaction area;
wherein energy emitted by the at least one energy emitter is also directed toward the reflective surface;
wherein the least one optical sensor also detects the energy reflected from the reflective surface and outputs signals representing the same to the computing device; and
wherein the computing device executes one or more program modules for detecting and interpreting movement within said interaction area based on changes in the energy reflected from within the interaction area and for determining whether an object is interacting with the secondary input means based on changes in the energy reflected from the reflective surface.

17. The optical coordinate input system of claim 16, wherein the reflective surface of the optical imaging secondary input means is separate from the plurality of reflective members surrounding the interaction area.

18. The touch screen system of claim 17, wherein the reflective surface of the optical imaging secondary input means and the one or more reflective members surrounding the interaction area are each selected from the group consisting of: reflective film, reflective tape, and reflective paint.

19. A optical touch sensitive system having an optical imaging secondary input means, comprising:
a display screen having a viewing area surrounded by a frame, the frame having one or more reflective members applied thereto;
a computing device interfaced with the display screen for executing one or more program modules for causing images to be displayed on the display screen;
at least one energy emitter for emitting energy that is directed toward the viewing area of the display screen and is reflected from within said viewing area by way of the one or more reflective members;
at least one optical sensor for detecting the energy reflected from within the viewing area and outputting signals representing the same to the computing device;
a secondary input means interfaced with the computing device, wherein the secondary input means comprises a reflective surface external to the viewing area of the display screen;
wherein energy emitted by the at least one energy emitter is also directed toward the reflective surface;
wherein the least one optical sensor also detects the energy reflected from the reflective surface and outputs signals representing the same to the computing device; and
wherein the computing device further executes one or more program modules for detecting touch point positions relative to the viewing area of the display screen based on changes in the energy reflected from within the viewing area and for determining whether an object is interacting with the secondary input means based on changes in the energy reflected from the reflective surface.

20. The computing system of claim 19, wherein the reflective surface of the optical imaging secondary input means is separate from the one or more reflective members.

21. The touch screen system of claim 20, wherein the reflective surface of the optical imaging secondary input means and the one or more reflective members are each selected from the group consisting of: reflective film, reflective tape, and reflective paint.

22. A optical touch sensitive system having an optical imaging secondary input means, comprising:
a viewing area surrounded by a frame, the frame having one or more reflective members applied thereto, the viewing area encompassing a display screen and an expanded area, at least one indicia representing a button or switch located within said expanded area;
a computing device interfaced with the display screen for executing one or more program modules for causing images to be displayed on the display screen; at least one energy emitter for emitting energy that is directed toward the viewing area and is reflected from within said viewing area by way of the one or more reflective members;
at least one optical sensor for detecting the energy reflected from within the viewing area and outputting signals representing the same to the computing device; and
wherein the computing device further executes one or more program modules for detecting touch point positions relative to the display screen and relative to the at least one indicia located within the expanded area based on changes in the energy reflected from within the viewing area.

23. The optical touch sensitive of claim 22, further comprising a glass plate applied to the front surface of the frame so as to cover the viewing area.

24. The optical touch sensitive of claim 23, wherein the at least one indicia is applied to a surface of the glass plate covering the expanded area.
